(19) United States
(12) Patent Application Publication
(10) Pub. No.: US 2014/0283132 A1
(43) Pub. Date: Sep. 18, 2014

(54) COMPUTING APPLICATION SECURITY AND DATA SETTINGS OVERRIDES

(71) Applicant: INTERNATIONAL BUSINESS MACHINES CORPORATION, Armonk, NY (US)

(72) Inventors: Stephen J. Kenna, Cary, NC (US); Dana L. Price, Cary, NC (US)

(73) Assignee: INTERNATIONAL BUSINESS MACHINES CORPORATION, Armonk, NY (US)

(21) Appl. No.: 13/797,199

(22) Filed: Mar. 12, 2013

(51) Int. Cl. G06F 21/60

(52) U.S. Cl. CPC G06F 21/60
USPC 726/29

(57) ABSTRACT

Provided are techniques for receiving a first request from a first application for a particular data element; making a determination, with respect to the first request, of whether or not to provide access to the particular data element to the first application; and in response to a determination to provide access to the first application, providing the first application with access to the particular data element; and in response to a determination not to provide access to the first application, providing the first application access to a first dummy data element.

### FIELD OF DISCLOSURE

The claimed subject matter relates generally to computer security and, more specifically, to techniques to enable a computer user to specify alternative security and data settings overrides.

### SUMMARY

Provided are techniques for enabling computer application users to override required security settings by providing default or alternative values for specific settings. In a typical computing environment many applications identify security levels and access permissions that are required for operation. For example, a to-do list application may require access to a user's contact list and an image processing application may require network access. Often, the user must accept required settings or the particular application will not install. This type of scenario is particularly common with respect to applications on mobile devices. For example, some mobile applications require access to the mobile device's location detection information. Such requirements may be frivolous or invasive and not entirely necessary or useful with respect to the desired functionality.

Provided are techniques for receiving a first request from a first application for a particular data element; making a determination, with respect to the first request, of whether or not to provide access to the particular data element to the first application; and in response to a determination to provide access to the first application, providing the first application with access to the particular data element; and in response to a determination not to provide access to the first application, providing the first application access to a first dummy data element.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is an example of a computing architecture that may implement the claimed subject matter.

FIG. 2 is a block diagram of a mobile telephone, first introduced in conjunction with FIG. 1, which is an example of a device that may implement the disclosed technology.

FIG. 3 is a block diagram a Privacy Protection Module (PPM), first introduced in FIG. 1, which may implement the claimed subject matter.

FIG. 4 is a flowchart of a Detect Application process that may implement aspects of the claimed subject matter.

FIG. 5 is a flowchart of a Privacy Protection process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium, would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data, processing apparatus, create means for implementing the functions/acts specified in the flowchart and/or block diagram block or blocks.

These computer program instructions may also be stored in a computer readable medium that can direct a computer, other programmable data, processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Turning now to the figures. FIG. 1 is an example of a computing architecture 100 that may implement the claimed subject matter, A computing system 102 includes a central processing unit (CPU) 104, coupled to a monitor 106, a keyboard 108 and a pointing device, or “mouse,” 110, which together facilitate human interaction with other components of computing architecture 100 and computing system 102. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown).

CRSM 112 is illustrated storing a Privacy Protection Module (PPM) 114 that incorporates the claimed subject matter. In the following examples, logic associated with PPM 114 is executed on one or more processors (not shown) of CPU 104, PPM 114 represents a privacy protection system in accordance with the disclosed technology and is described in more detail below in conjunction with FIGS. 2-5. It should be noted that a typical computing system would typically include more components and applications, but for the sake of simplicity a few are illustrated.

Computing system 102 and CPU 104 are connected to the Internet 120, which is also connected to a server computer 122. Although in this example, computing system 102 and server 122 are communicatively coupled via the Internet 120, they could also be coupled through any number of communication mediums such as, but not limited to, a local area network (LAN) (not shown). Coupled to server 122 is a CRSM 124, which is illustrated storing an application, or app_{—}1, 126, which is used as an example of an application that may be subject to control by the policies implemented by PPM 114. Also attached to the Internet 120 is a wireless system 130. Wireless system 130 may be, but is not limited to, a cellular telephone network, a Wi-Fi network or any other existing or yet to be developed communication system. Coupled to wireless system 130 are a mobile telephone 132 and a mobile computing device, or computer, 134. Mobile telephone 132 and mobile computer 134 are merely examples of devices that may implement the claimed, subject matter. En the following description, computing system 102 and mobile telephone 132 are primarily used as the example. It should be noted there are many possible computing system configurations, of which computing system 100 is only one simple example.

FIG. 2 is a block diagram of mobile telephone 132, first introduced in conjunction with FIG. 1, which is one example of a device that may implement the disclosed technology. Mobile telephone 132 includes a CPU 150 coupled to a communication bus 152. Also coupled to bus 152 are a display 154, a keyboard 156, an input/output module (I/O) 158 and a CRSM 162. Each of components 150, 152, 154, 156, 158 and 162 should be familiar to those with skill in the relevant arts. It should also be understood that mobile telephone 132 is merely one simple example of a mobile telephone and that the disclosed technology is equally applicable to other types as well. For example, in addition to or rather than keyboard 156, mobile telephone 132 may have a touchscreen (not shown).

CRSM 162 is illustrated as storing an operating system (OS) 164, an application, or “app_{—}2,” 166 and a PPM 168. Logic associated with OS 164, app_{—}2 166 and PPM 168 are executed on one or more processors (not shown) of CPU 150. Through the remainder of the Description, mobile telephone 132 is used as an example of a device that may implement the claimed subject matter. It should be understood that the claimed subject matter may also be implemented on practically any computing device.

FIG. 3 is a block diagram PPM 168, first introduced in FIG. 2, which may implement the claimed subject matter. Although PPM 168 may be installed on practically any computing device, such as but not limited to computing system 102 and mobile computing device 134, the following example describes PPM 168 as installed on mobile telephone 132.

PPM 168 includes an application detection module (ADM) 172, a user interface (UI) 174, an application interface (AI) 176 and a data module 178. ADM 172 stores logic for the detection of interactions between mobile telephone 132 and both external applications such as app_{—}1 126 (FIG. 1) and internal applications such as app_{—}2 166 (FIG. 2). UI 174 includes logic to enable user interaction with PPM 166 including, but not limited to, logic for setting parameters to control the operation of PPM 166 (see option data 188) and for providing various actual and dummy user data (see user data 182 and dummy data 184). AI 176 includes logic to control interactions between PPM 166 and both external applications such as app_{—}1 126 and internal applications such as app_{—}2 166.

Data module 178 stores information employed by PPM 166 to operate, including but not limited to, user data 182, fill data 184, application data 186, option data 188 and executable logic 190. User data 182 may include information concerning the user of mobile telephone 132. In addition, user data 182 may include information pointing to actual and dummy databases and files for which access might be requested by applications. Examples include, but are not limited to, calendar information, internet access, location monitoring, writing to SD cards and so on. Other information may include, but is not limited to, valid contact information and parameters that control the manner in which that contact information may be shared with particular applications. For example, there may be a parameter that specifies specific information that may be shared with an internal application such as app_{—}2 166 but not shared without explicit permission with external applications such as app_{—}1 126. Fill data 184 stores “dummy” information employed when the user has specified that a particular application should not receive valid information. For example, some applications may require that requested data be supplied before the application may be executed but the user may prefer not to supply that information. In this manner, the user can still use the application without revealing unnecessary personal information while being able to provide some accurate information, i.e. selecting what, actual information to provide and otherwise supplying dummy information. For example, user might be will to provide location information so that a mapping function can operate correctly but supply a pointer to a dummy contacts database so that actual contacts information may remain private.

Application data 186 stores information both on specific applications and on different types of applications classified into groups. For example, internal applications may be defined as one group and external, application as another. In addition, once a user has selected that either actual information or dummy information be provided to a particular application, application data 186 stored that selection in conjunction with the particular application. Executable logic 190 stores programming code for controlling the operation of PPM 166, Components 172, 174, 176 and 178 and data modules 182, 184, 186, 188 and 190 are explained in more detail below in conjunction with FIGS. 4 and 5.

FIG. 4 is a flowchart, of a Detect Application process 200 that may implement aspects of the claimed subject matter, in this example, logic associated with process 200 is stored on CRSM 162 (FIG. 1) in conjunction with PPM 168 (FIGS. 2 and 3) and executed on one or more processors (not shown) of CPU 150 (FIG. 2) of mobile telephone 132 (FIGS. 1 and 2). Process 200 starts in a “Begin Detect Application” block 202 and proceeds immediately to a “Detect Load Request” block 204. During processing associated with block 204, a request to load an application is detected. Typically, an operating system (OS) such as OS 164 (FIG. 2) may be configured to perform particular actions when a load request is received. Although in this example, one such action would be to invoke PPM 168 (FIG. 2), In an alternative embodiment, rather than detecting a load request, OS 164 or PPM 168 may detect the invocation of particular application programming interfaces (APIs) that access security interfaces.

During processing associated, with a “Security Access?” block 206, a determination is made as to whether or not the load request detected during processing associated with block 204, or simply a request to access an API, involves a security access request. If not, control proceeds to a “Load Application” block 212 and the application that has requested to be loaded is loaded for execution.

If a determination is made that a security access request has been received, control proceeds to an “Authorized (Auth.) Application?” block 208. During processing associated with block 208, a determination is made as to whether or not the application that is requesting to be loaded (or calling the API) has been approved for such access. Such a determination may be made based upon information stored as parameters in conjunction with PPM 166 (see 186, FIG. 3). If the application is an approved application, control proceeds to Load Application block 212 and the application is loaded without restrictions. If the application is not approved, control proceeds to “Select Permissions/Settings block 210 (see 250, FIG. 5).

There are two types of applications that may be detected at this point, an application that has been previously processed by PPM 166; and one that has not. If an application has already been processed with respect to PPM 166, an administrator may have already established security parameters. In that case, particular settings, parameters and fill data (see 184, FIG. 3) may be simply retrieved from PPM 166, If the application has not previously been processed, UI 174 (FIG. 3) may display a graphical user interface (GUI) that enables an administrator or user to establish settings, parameters and fill data for the particular application.

During processing associated with Load Application block 212, the application is loaded with actual or dummy parameters. Finally, during processing associated with an “End Detect Application” block 219, process 200 is complete.

FIG. 5 is a flowchart of a Privacy Protection process 250 that may implement aspects of the claimed subject matter. Like process 200, in this example, logic associated with process 250 is stored on CRSM 162 (FIG. 1) in conjunction with PPM 168 (FIGS. 2 and 3) and executed on one or more processors (not shown) of CPU 150 (FIG. 2) of mobile telephone 132 (FIGS. 1 and 2).

Process 250 starts in a “Begin Select Permissions/Settings” block 252 and proceeds immediately to a “Parse Application” block 254. During processing associated with block 254, an application being loaded (see 204, 206, FIG. 4) is analyzed to determine if any security accesses are required or requested. During processing associated with block a “Request Permissions?” block 256, a determination is made as to whether or not the application requires that any permissions be set. If so, control proceeds to an “Enable Permission Selection” block 258. During processing associated with block 258, a GUI is displayed that enables a user to define the acceptable permissions for the application.

Once permissions have been selected during processing associated with block 258 or a determination is made, during processing associated, with block 256 that no special permissions are required, control proceeds to a “Data Required?” block 260. During processing associated with block 260, a determination is made as to whether or not the application requests access to any particular data. For example, an application may require that the user's name be divulged and that the application have access to the user's contacts list. These two examples of data elements will be used to describe processing associated with addition blocks in process 250. Of course, it should be understood that there are many different types of data that different application may request but for the sake of simplicity only two are described. If data is required, processing proceeds to a “Select Element” block 262.

During processing associated with block 262, one of the requested data elements is identified, which, in this example, the first time through block 262 is the user's name. During processing associated with an “Alternative (Alt.) Wanted?” block 264, a determination is made as to whether or not the application should be provided with real or alternative, or “dummy,” data, if alternative data is not selected, control proceeds to a “Provide Element” block 266 during which the application is provide with access to the actual data. Such access may be provided by actually supplying the data or simply pointing the application to a location where the real data is stored, if the data is something as simple as a name, the data may just be provided. If the data is more complex, such as a contact list, a file, database or memory location may be provided.

If, daring processing associated with block 264, a determination is made that alternative data is preferable, control proceeds to a “Select/Define Alt. Data” block 268. During processing associated with block 268, either dummy data has already been defined, and is stored hi fill data 184 (FIG. 3) of PPM 118 or the user defines data to be supplied. For example, a user may provide the coordinates of the North Pole rather than provide actual location data or provide a dummy address book rather than reveal private contact information. As with real data, simple data may just be provided while with more complex data a dummy file, database or memory location may be created and referenced.

If at this point the user defines new data, the result may be stored in fill data 184 for use in future data access requests. Once data has been retrieved or defined during processing associated with block 268 or real data provided during processing associated with block 266, control proceeds to a “More Elements?” block 270. During processing associated with block 270, a determination is made as to whether or not there are more data elements to be processed, if so, control returns to block 262, another element, which in this example is the user's contact list, is selected and processing continues as described above.

Finally, once a determination is made during processing associated with block 270 that all data elements have been processed or, if during processing associated with block 260, a determination is made that no data access is required, control proceeds to an “End Select Permissions/Settings” block 279 during which process 250 is complete.

The terminology used herein is for the purpose of describing particular embodiments only and is not intended, to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been, presented for purposes of illustration and description, but is not intended to be exhaustive or limited to the invention in the form disclosed. Many modifications and variations will be apparent to those of ordinary skill in the art without departing from the scope and spirit, of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified, logical, function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising;
receiving a first request from a first application for a particular data element;
making a determination, with respect to the first request, of whether or not to provide access to the particular data element to the first application; and
in response to a determination to provide access to the first application, providing the first application with access to the particular data element; and
in response to a determination not to provide access to the first application, providing the first application access to a first dummy data element.

2. The method of claim 1, further comprising storing the first dummy data element for use in a subsequent request from an application for the particular data element.

3. The method of claim 1, further comprising:
receiving a second request from a second application for the particular data element;
making a determination, with respect to the second request, of whether or not to provide access to the particular data element to the second application; and
in response to a determination to provide access to the second application, providing the second application with access to the particular data element; and
in response to a determination not to provide access to the second application, providing the second application access to a second dummy data, element, wherein the second dummy data element, has a different value than the first dummy data element.

4. The method of claim 1, further comprising;
receiving a second request from the first application for the particular data element, wherein, a determination with respect to the first request was not to provide access; and
making a second determination, with respect to the second request, to provide access to the particular data element to the first application.

5. The method of claim 1, wherein the particular data element is location information.

6. The method of claim 1, wherein the particular data element is contact information.

7. The method of claim 1, further comprising generating a user interface to enable a user to make the determination as to whether or not to provide access to the particular data element to the first application.

8. An apparatus, comprising:
a processor;
a computer-readable storage medium coupled to the processor; and
logic, stored on the computer-readable storage medium and executed on the processor, for:
receiving a first request from a first application for a particular data element;
making a determination, with respect to the first request, of whether or not to provide access to the particular data element to the first application; and
in response to a determination to provide access to the first application, providing the first application with access to the particular data element; and
in response to a determination not to provide access to the first application, providing the first application access to a first dummy data element.

9. The apparatus of claim 8, the logic further comprising logic for storing the first dummy data element for use in a subsequent request from an application for the particular data element.

10. The apparatus of claim 8, the logic further comprising logic for:
receiving a second request from a second application for the particular data element;
making a determination, with respect to the second request, of whether or not to provide access to the particular data element to the second application; and
in response to a determination to provide access to the second application, providing the second application with access to the particular data element; and
in response to a determination not to provide access to the second application, providing the second application access to a second dummy data element, wherein the second dummy data element has a different value than the first dummy data element.

11. The apparatus of claim 8, the logic further comprising logic for:
receiving a second request from the first application for the particular data element, wherein a determination with respect to the first request was not to provide access; and
making a second determination, with respect to the second request, to provide access to the particular data element to the first application.

12. The apparatus of claim 8, wherein the particular data element is location information.

13. The apparatus of claim 8, wherein the particular data element is contact information.

14. The apparatus of claim 8, the logic further comprising logic for generating a user interface to enable a user to make the determination as to whether or not to provide access to the particular data element to the first application.

15. A computer programming product, comprising:
a computer-readable storage medium coupled to the processor; and
logic, stored on the computer-readable storage medium for execution on a processor, for:
receiving a first request from a first application for a particular data element;
making a determination, with respect to the first request, of whether or not to provide access to the particular data element to the first application; and
in response to a determination to provide access to the first application, providing the first application with access to the particular data element; and
in response to a determination not to provide access to the first application, providing the first application access to a first dummy data element.

16. The computer programming product of claim 15, the logic further comprising logic for storing the first dummy data, element for use in a subsequent request from an application for the particular data element.

17. The computer programming product of claim 15, the logic further comprising logic for:
receiving a second request from a second application for the particular data element;
making a determination, with respect to the second request, of whether or not to provide access to the particular data element to the second application; and
in response to a determination to provide access to the second application, providing the second application with access to the particular data element; and
in response to a determination not to provide access to the second application, providing the second application access to a second dummy data element, wherein the second dummy data element has a different value than the first dummy data element.

18. The computer programming product of claim 15, the logic further comprising logic for:
receiving a second request from the first application for the particular data element, wherein a determination with respect to the first request was not to provide access; and
making a second determination, with respect to the second request, to provide access to the particular data element to the first application.

19. The computer programming product of claim 15, wherein the particular data element is location information.

20. The computer programming product of claim 15, wherein the particular data element is contact information.
